(19) United States
(12) Patent Application Publication
(10) Pub. No.: US 2006/0261194 A1
(43) Pub. Date: Nov. 23, 2006

(54) Conduit water-saving irrigating device with the conduit and its application

(76) Inventor: Rongwu Ding, QUZNZHOU (CN)

Correspondence Address: GREER, BURNS & CRAIN, 300 S WACKER DR, 25TH FLOOR, CHICAGO, IL, 60606, US

(21) Appl. No.: 10/543,578

(22) PCT Filed: Jan. 13, 2004
(86) PCT No.: PCT/CN04/00037

§ 371 Date: Apr. 17, 2006

(30) Foreign Application Priority Data
Jan. 27, 2003 (CN) 03111787.2
Jul. 31, 2003 (CN) 03269245.5

(51) Int. Cl. B05B 15/00; B05B 1/26; F23D 11/36

(52) U.S. Cl. 239/542; 239/543; 239/547

(57) ABSTRACT

The invention discloses a hollow conduit including a cylindrical wall with protrusion portions, on which provided with a groove having through-hole for outflow, and a water-saving irrigating device comprised of the conduit and a baffle-piece, which is mounted in the groove. There is a gap between the baffle-piece and the groove. The conduit can be used to feed both water and gas. Water inside of the conduit can seepage and vaporize into the soil through the gap. The invention, which possess advantages of simple structure, easy to manufacture and lay out, high efficiency of irrigating and saving water, quantitative controlling of irrigating water, especially adapts to hot desert areas where lack of water.

### BACKGROUND OF THE INVENTION

1. Field of the Invention

The present invention generally relates to a conduit a water-saving irrigating device using the same and its application in the environmental reconstruction.

2. Background Technology

Because of the natural conditions and mankind's unreasonable exploitage, serious desertification phenomenon has appeared in all parts of the world. The deterioration of the ecological environment, which restricts the economic development and threatens the human living environment, such as desert, aridity, water depletion, high temperature, fast evaporation of water, barren land, salinization of soil, ect, has become a world wide problem. To remodel such abominable natural environment, the primary task is to plant forest to resume the vegetation. To achieve good effect in forest planting, it is important to adopt feasible and high-efficient water-saving irrigating and water storing device and technology, which can provide sufficient water and fertilizer for plants. On this basis, keep remodeling the ecological environment to construct an environment suitable for plant's growth

In the aspect of water-saving irrigation, there are various practical applications at present, such as overhead irrigation, drip irrigation, buried irrigation etc. The core of those water-saving irrigating devices is adopting conduits with different structures, which can control the conveying of the water and the fertilizer to improve the usage of water and the efficiency of irrigating. Practices show that the buried irrigation has good effect in reducing water evaporation and storing water in the soil. The so-called buried irrigating is an irrigating method that the conduits are buried underground to supply water to plants directly. An existing buried irrigating device generally includes a hollow conduit with outlets on its wall. Water inside the conduit can osmosis into the soil through those outlets. However, the existing buried irrigating device is not suited to be used in desert areas because of the following disadvantages: 1, its irrigating water is uncontrollable that the water supply may sometimes be excess or shortage, which is unfavorable to the growth of plants; 2, the outlets may easily be blocked by sands and impurities in the soil. Although some methods were tried to solve the above problems, such as adding cottons in outlets arid covering screens on outlets, desired effect was not achieved because of their unreasonable structures and bad practicability, furthermore, those methods may even influence the irrigating effect.

In the aspect of water-storing, there is few device and technology capable of storing underground water in desert areas at present. In accordance with the investigation to the vegetation in arid areas in west China taken by experts of China and Europe for several years, only irrigating can not improve the growing condition for plants, to allow plants to grow healthy, it is most important to maintain a stable underground water supply.

The remodeling of the ecological environment of desert areas is based on efficient water-saving irrigating and water maintaining. At present, because of lacking economic and feasible water-saving and water-maintaining devices and technologies, although the remodeling of the ecological environment of desert areas is greatly invested, it gets half the result and becomes a world wide problem.

### BRIEF SUMMARY OF THE INVENTION

The first purpose of the present invention is to provide a new type conduit that eliminates the above described disadvantages and problems.

The second purpose of the present invention is to provide a water-saving irrigating device constructed of the above mentioned conduit.

The third purpose of the present invention is to provide a method to remodel ecological environment using said water-saving irrigating device.

In accordance with the fist purpose of the present invention, one aspect of the new type conduit is: a new type conduit is a hollow conduit with two bosses symmetrically set on its outer wall, each boss respectively includes a groove, and two rows of outlets which can communicate with the interior of the conduit are separately disposed along the grooves.

Another aspect of the new type conduit is: two bosses are symmetrically set on its outer wall as two ears, each boss respectively includes a groove, and two rows of outlets which can communicate with the interior of the conduit are separately disposed along the grooves, the two rows of outlets are symmetrical.

Still another aspect of the new type conduit is: the two bosses extend along the outer wall of the conduit parallelly to the axis line of the conduit.

In accordance with the second purpose above-described, one aspect of the water-saving irrigating device provided in the present invention is: the water-saving irrigating device is comprised of a said conduit and guard boards, two bosses are symmetrically set on the outer wall of said conduit, each boss respectively includes a groove, and two rows of outlets which can communicate with the interior of the conduit are separately disposed along the grooves; the guard boards are respectively disposed within the grooves, between a guard board and a groove there forms a gap through which the outlets communicate with the outside.

Another aspect of the water-saving irrigating device is: two bosses are symmetrically set on the outer wall of said conduit, each boss respectively includes a groove, and two rows of outlets which can communicate with the interior of the conduit are separately disposed along the grooves; the guard boards are respectively disposed within the grooves, between a guard board and a groove there forms a gap through which the outlets communicate with the outside.

Still another aspect of the water-saving irrigating device is: the two bosses extend along the outer wall of the conduit parallelly to the axis line of the conduit

A further aspect of the water-saving irrigating device is: the guard boards in the grooves are mobilizable.

A still further aspect of the water-saving irrigating device is: there forms a water-storing gap between a guard board and the bottom of a groove.

Yet another aspect of the water-saving irrigating device is: the conduits of the water-saving irrigating devices are connected using connectors; a water pump, a main conduit, and branch conduits form an irrigating system, this irrigating system is laid into a netted structure.

Yet still another aspect of the water-saving irrigating device is: there is a composite water-holding layer laid below the conduits, the said composite water-holding layer includes a basic sheet of which the upper surface is coated with a water-proofing agent and the lower surface is coated with a water-absorbing agent.

With reference to the three purposes above-described, the present invention can be applied in ecological environment remodeling.

One aspect of the application in ecological environment remodeling of the present invention is: the conduits transport soil ameliorants to continuously improve the quality of the soil.

Another aspect of the application in ecological environment remodeling of the present invention is: the conduits transport the microbial fungi or bacteria to improve the soil characteristics.

The new type conduit above-described can transport fertilizers of liquid and gas.

When in use, the water-saving irrigating device above-described is buried into the soil with the two rows of outlets disposed in a horizontal plane. Compared with traditional irrigating devices, it has following advantages: (1) when water is supplied, some water inside the conduit flows out through the outlets, in this course the water raises the guard boards up that forms between the bottom of a guard board and one internal side wall of a boss a gap through which the water flows out and into soil, and some water remains. The amount of irrigating water can be controlled by counting the water environment in the soil and weather conditions of different areas; (2) after water supply is stopped, below the horizontal plane defined by the two rows of outlets there is still a certain amount of water remains, when the temperature in soil around is high enough, the remaining water evaporates and then becomes vapor which goes out of the conduit through a gap between the top of a guard board and the internal upper side wall of a boss and soaks into the soil around the conduit In hot desert areas, not only it maintains the water supply but also reduces the temperature of the soil, which is favorable for plant's growth; (3) when water supply is stopped, the internal upper half of the conduit is empty, this empty space can be used to transport gaseous fertilizers, such as nitrogen, ammonia gas etc., those gaseous fertilizers go out of the conduit through the gap between the top of a guard board and the internal upper side wall of a boss; (4) a composite water-holding layer is laid below the irrigating conduits, this composite water-holding layer includes a upper surface which is coated with a water-holding agent capable of holding water seepage from the conduits and the aboveground and a lower surface which is coated with a water-absorbing agent capable of absorbing water to the adjacent place for plants to suck, it can hold and store water, utilize water resource aboveground and underground fully, and supply sufficient water and fertilizers to plants; (5) the conduit can also be utilized to transport soil ameliorants and microbial fungi or bacteria for continuously improving the quality of the soil; (6) the conduit is constructed of improved PVC material that it can work underground for almost 50 years, which greatly reduces the cost for repairing and renewing the equipments.

In sum, the new type conduit and water-saving irrigating device has multi functions of saving water, maintaining water supply, holding water and transporting fertilizers and soil ameliorants by using reasonably arranged outlets, guard boards and grooves. The water-saving irrigating device is of simple structure and easy to be laid and arranged in the soil, it is also highly efficient in irrigating, water saving and water holding. When planting forest in desert areas where are hot and water-deficient, the water-saving irrigating device present in this invention is able to promote plants to grow fast and increase the survival rate of plants, which is a efficient and low-cost way and device to remodel the ecological environment in desert areas.

### BRIEF DESCRIPTION OF THE DRAWINGS

The present invention will be described with greater specificity and detail through the use of the accompanying drawings, in which:

FIG. 1 is a principal view of a new type conduit;

FIG. 2 is a left view of the conduit shown in FIG. 1;

FIG. 3 is a top cross-sectional view of the conduit shown in FIG. 2;

FIG. 4 is a principal view of a water-saving irrigating device including the conduit shown in FIG. 1;

FIG. 5 is a left view of the water-saving irrigating device shown in FIG. 4;

FIG. 6 is a top cross-sectional view of the water-saving irrigating device shown in FIG. 5;

FIG. 7 is a general view of the water-saving irrigating device shown in FIG. 4, illustrating the device irrigating;

FIG. 8 is a general view of the water-saving irrigating device shown in FIG. 4, illustrating water vapor in the device dispersing out;

FIG. 9 is a plan view of a laid water-saving irrigating device.

FIG. 10 is a cross-sectional view of the laid water-saving irrigating device shown in FIG. 9.

### DETAILED DESCRIPTION OF THE PREFERRED EMBODIMENTS

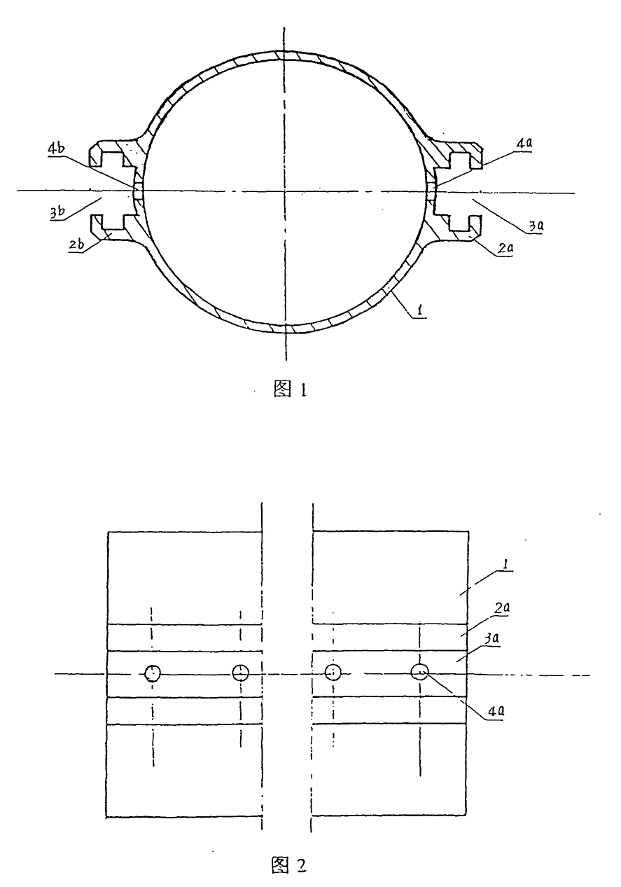

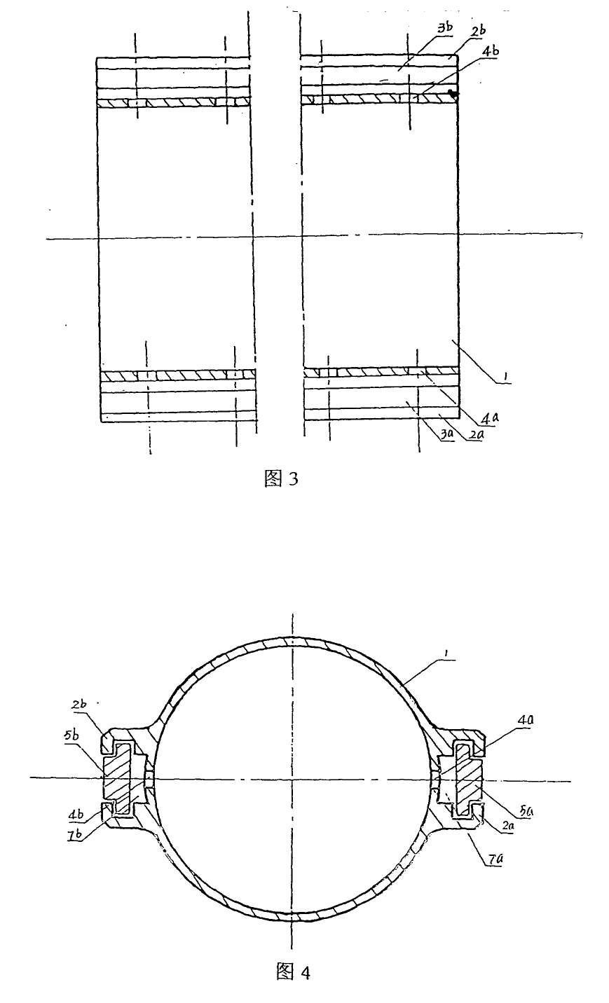

With reference to FIG. 1, FIG. 2 and FIG. 3, a new type conduit is a hollow tube 1 with two bosses 2a, 2b symmetrically set on its opposite outer wall as two ears. The two bosses 2a, 2b extend along the outer wall of the conduit 1 parallelly to the axis line of the conduit 1. Each boss 2a or 2b respectively includes a groove 3a or 3b. Two rows of outlets 4a and 4b which can communicate with the interior of the conduit are separately disposed along the grooves 3a and 3b. The two rows of outlets 4a and 4b are symmetrical. The conduit can be extensive produced in commercial process using existing devices of producing PVC conduits.

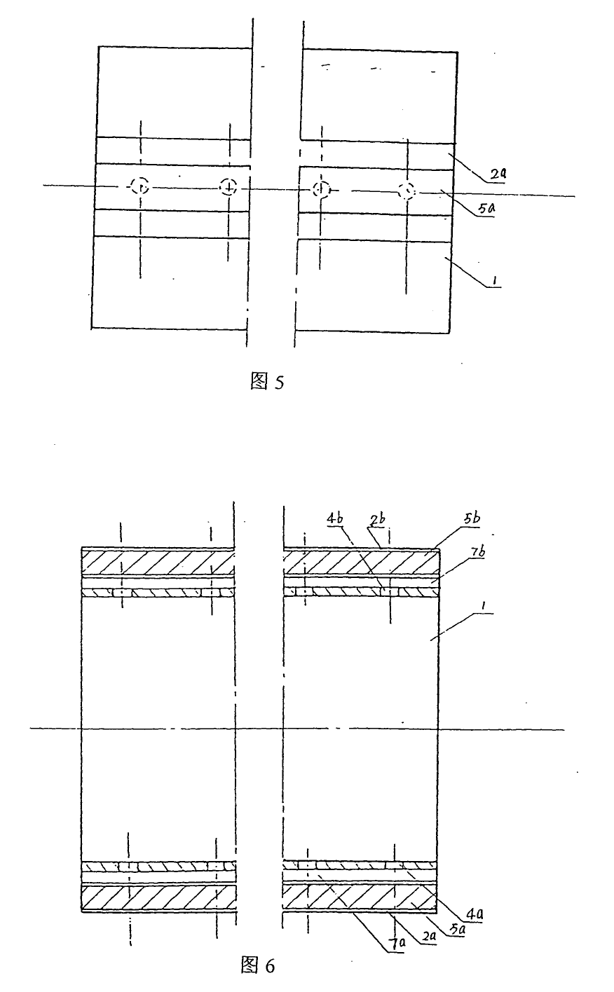

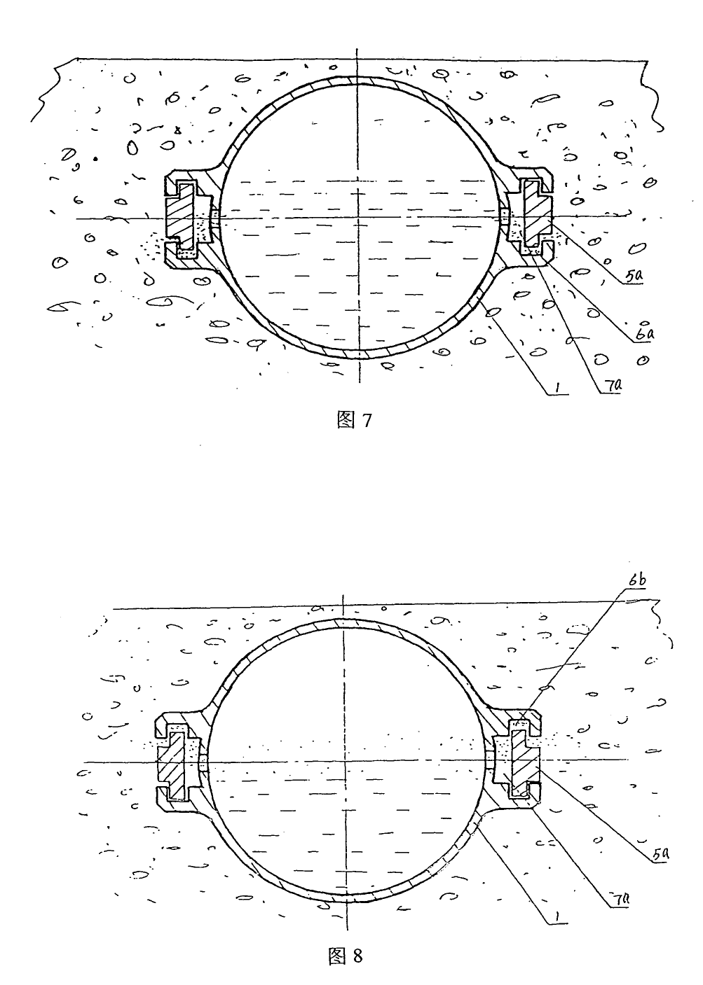

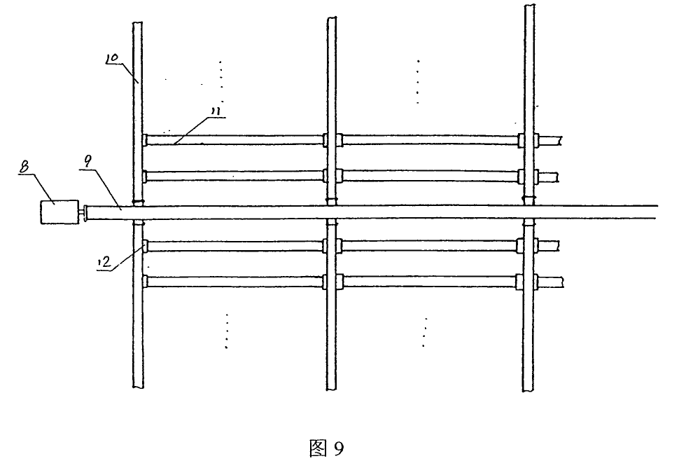

With reference to FIG. 4, FIG. 5 and FIG. 6, a water-saving irrigating device is comprised of the above-described conduit 1 and guard boards 5a and 5b which are respectively disposed within the grooves 3a and 3b. The height of a guard board is slightly smaller than the height of a groove, and the thickness of a guard board is slightly smaller than the depth of a groove. Guard boards 5a and 5b are mobilizable in the grooves 3a and 3b, which is convenient for the guard boards 5a and 5b to be embedded into or fetched out of the grooves 3a and 3b and more important forms a seepage gap between the grooves 3a, 3b and the guard boards 5a, 5b. With reference to FIG. 7 and FIG. 8, when a water-saving irrigating device is buried, the outlets 4a and 4b are disposed in a horizontal plane. When water is supplied, water inside the conduit 1 flows out through the outlets 4a and 4b, in this course the water raises the guard boards 5a and 5b up that forms between the bottom of a guard board 5a or 5b and one internal side wall of a boss 2a or 2b a gap 6a through which the water flows out and into soil; after water supply is stopped, below the horizontal plane defined by the two rows of outlets there is still a certain amount of water remains, when the temperature in soil around is high enough, the remaining water is evaporated and then becomes vapor which goes out of the conduit 1 through a gap 6b between the top of a guard board 5a or 5b and the internal upper side wall of a boss 2a or 2b and soaks into the soil around the conduit 1.

The gap between a guard board 5a or 5b and the bottom of a groove 3a or 3b forms a water-storing gap 7a or 7b which can store a certain amount of water for continually supplying when the water in the conduit 1 has been exhausted.

With reference to FIG. 8, when water supply is stopped, the internal upper half of the conduit 1 is empty. This empty space can be used to transport gaseous fertilizers, such as nitrogen, ammonia gas etc. Those gaseous fertilizers go out of the conduit 1 through the gap 6b between the top of a guard board 5a or 5b and the internal upper side wall of a boss 2a or 2b.

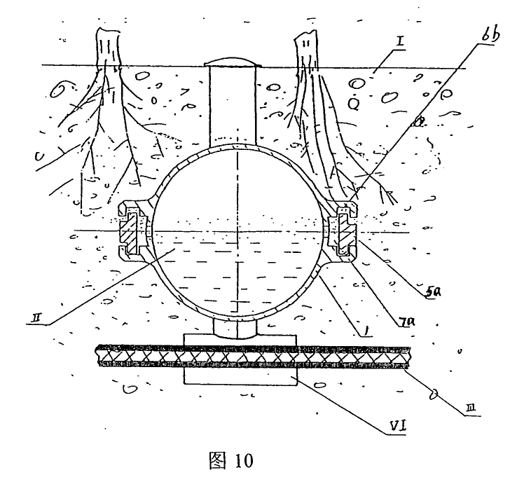

FIG. 9 is a plan view of a laid out water-saving irrigating device. As best seen in FIG. 9, a water-saving irrigating system includes a water pump 8, a main conduit 9, branch conduits 10 connected to the main conduit 9 through connectors 12, and conduits 1 of irrigating apparatus 11 connected to the branch conduits 10 using connectors 12. The arrangement of the system is similar to a root system of plants and acts as a reservoir underground. By counting the water environment in the soil and weather conditions of different areas and taking the conduit's capability into consideration, the water supply of a water-saving irrigating device can be calculated and the arrangement of a water-saving irrigating device can be properly designed, which performs a water-constant irrigation that is highly efficient. The water-constant irrigation is capable of providing basically necessary water for plants and saving water. The water-saving irrigating device may be used to transport soil ameliorants which can continuously improve the soil quality. Further, the water-saving irrigating device may also be used to transport microbial fungi or bacteria that is anaerobic, aerobic, or halophilous etc. Those microbial fungi or bacteria acts a function of transforming organic substances into inorganic substances, which allows the soil quality to be more efficiently improved to be more suitable for the plant's growth.

FIG. 10 is a cross-sectional view of the laid out water-saving irrigating device, wherein the water-saving irrigating device II is buried in the soil I, and a composite water-holding layer which lies III below the conduits 1. The water-saving irrigating device still includes a shaft apparatus VI which is constructed of a plastic barrel or a large diameter barrel of PVC plastic. The shaft apparatus VI is connected to conduits 1 by connectors and is vertically disposed, it can be used to receive precipitations of sand clay from conduits 1, which guarantees the conduits are unblocked and acts a function of storing water. The shaft apparatus VI extends upwards beyond the ground surface and is covered by a removable cover, which allows the shaft apparatus VI to be watched and cleaned at any time.

The composite water-holding layer III includes a base sheet of which the upper surface is coated with a water-proofing agent and the lower surface is coated with a water-absorbing agent. The base sheet is constructed of innocuous polyacrylic non-woven fabrics having a density of 20 grams per square meter 30 grams per square meter, the water-proofing agent adopts natural glues, and the water-absorbing agent adopts a material of polyvinyl alcohol. The polyvinyl alcohol can automatically dissolve, so it does not damage the environment. In arid, water deficient and fertilizer deficient desert areas, the above described composite water-holding layer III can hold and store water, utilize water resource aboveground and underground fully, and supply sufficient water and fertilizers to plants.

The above-described water-saving irrigating device has been taken in practices in desert areas in Xinjiang autonomous region in China and now is being widely spread. The practices show that the water-saving irrigating device has advantages of low cost and high working efficiency and capabilities of promoting plants to grow fast and increasing the survival rate of plants.

### INDUSTRIAL APPLICATIONS

The conduit provided in the present invention is especially used to construct a special water-saving irrigating device which has multi functions of saving water, maintaining water supply, holding water and transporting fertilizers and soil ameliorants by using reasonably arranged outlets, guard boards and grooves. The water-saving irrigating device is of simple structure and easy to be laid and arranged in the soil, it is also highly efficient in irrigating, water saving and water holding. When planting forest in desert areas where are hot and water-deficient, the water-saving irrigating device present in his invention is able to promote plants to grow fast and increase the survival rate of plants, which is a efficient and low-cost way and device to remodel the ecological environment in desert areas.

1. A new type conduit, which is hollow, wherein two bosses are symmetrically set on its outer wall, each boss respectively includes a groove, and two rows of outlets which can communicate with the interior of the conduit are separately disposed along the grooves.

2. A water-saving irrigating device comprised of the conduit recited in claim 1 and guard boards, wherein two bosses are symmetrically set on the outer wall of said conduit, each boss respectively includes a groove, and two rows of outlets which can communicate with the interior of the conduit are separately disposed along the grooves; the guard boards are respectively disposed within the grooves, between a guard board and a groove there forms a gap through which the outlets communicate with the outside.

3. The new type conduit as recited in claim 1, wherein the two bosses are symmetrically set on its outer wall as two ears, each boss respectively includes a groove, and two rows of outlets which can communicate with the interior of the conduit are separately disposed along the grooves, the two rows of outlets are symmetrical.

4. The new type conduit as recited in claim 1, wherein the two bosses extend along the outer wall of the conduit parallelly to the axis line of the conduit.

5. The water-saving irrigating device as recited in claim 2, wherein the two bosses are symmetrically set on the outer wall of said conduit as two ears, each boss respectively includes a groove, two symmetrical rows of outlets which can communicate with the interior of the conduit are separately disposed along the grooves, guard boards are respectively disposed within the grooves, and between a guard board and a groove there forms a gap through which the outlets communicate with the outside.

6. The new type conduit as recited in claim 2, wherein the two bosses extend along the outer wall of the conduit parallelly to the axis line of the conduit.

7. The new type conduit as recited in claim 2, wherein the guard boards in the grooves are mobilizable.

8. The new type conduit as recited in claim 2, wherein there forms a water-storing gap between a guard board and the bottom of a groove.

9. The new type conduit as recited in claim 2, wherein the height of a guard board is slightly smaller than the height of a groove; wherein the thickness of a guard board is slightly smaller than the depth of a groove.

10. The water-saving irrigating device as recited in claim 2, wherein the conduits of the water-saving irrigating devices are connected using connectors; a water pump, a main conduit, and branch conduits form an irrigating system, this irrigating system is laid into a netted structure.

11. The water-saving irrigating device as recited in claim 2, further comprising a composite water-holding layer which lies below the conduits, wherein the composite water-holding layer includes a basic sheet of which the upper surface is coated with a water-proofing agent and the lower surface is coated with a water-absorbing agent.

12. The water-saving irrigating device as recited in claim 2, wherein a composite water-holding layer which lies below the conduits is included.

13. The water-saving irrigating device as recited in claim 12, wherein the said composite water-holding layer includes a basic sheet of which the upper surface is coated with a water-proofing agent and the lower surface is coated with a water-absorbing agent.

14. The water-saving irrigating device as recited in claim 12, wherein the base sheet is constructed of non-woven fabrics, the water-proofing agent adopts natural glues, and the water-absorbing agent adopts a material of polyvinyl alcohol.

15. (canceled)

16. (canceled)

17. (canceled)

18. The new type conduit as recited in claim 3, wherein the two bosses extend along the outer wall of the conduit parallelly to the axis line of the conduit.

19. The new type conduit as recited in claim 5, wherein the two bosses extend along the outer wall of the conduit parallelly to the axis line of the conduit.

20. The new type conduit as recited in claim 5, wherein the guard boards in the grooves are mobilizable.

21. The new type conduit as recited in claim 5, wherein there forms a water-storing gap between a guard board and the bottom of a groove.

22. The new type conduit as recited in claim 5, wherein the height of a guard board is slightly smaller than the height of a groove; wherein the thickness of a guard board is slightly smaller than the depth of a groove.

23. The water-saving irrigating device as recited in claim 13, wherein the base sheet is constructed of non-woven fabrics, the water-proofing agent adopts natural glues, and the water-absorbing agent adopts a material of polyvinyl alcohol.
